(19) United States
(12) Patent Application Publication
(10) Pub. No.: US 2005/0198627 A1
(43) Pub. Date: Sep. 8, 2005

(54) Loop transformation for speculative parallel threads

(75) Inventors: Zhao Hui Du, Shanghai (CN); Tin-Fook Ngai, Santa Clara, CA (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/794,052

(22) Filed: Mar. 8, 2004

(51) Int. Cl. G06F 9/45

(52) U.S. Cl. 717/160

(57) ABSTRACT

Sequential loops in computer programs may be identified and transformed into speculative parallel threads based on partitioning dependence graphs of sequential loops into pre-fork and post-fork regions.

### BACKGROUND OF THE INVENTION

Some embodiments of the present invention may relate generally to software optimization, and/or to optimizing sequential loops for speculative parallel execution during code compilation.

In computers with the ability to perform parallel processing, sequential loops in computer code can often be transformed with the use of parallel threads to allow more parallel execution of the loop. As seen, for example, in FIG. 1, during an iteration 106 of a sequential loop, the master thread 102 may spawn a speculative parallel thread (SPT) 104 to execute the next iteration 108 while the master thread 102 continues to execute the post-fork region 107 of the current iteration 106 of the loop. The SPT thread may execute both the pre- and post-fork regions in the next iteration 108. When the SPT 104 results are correct, the master thread 102 may commit the result at 110 and may proceed with the following iteration 112. If the results from the SPT 104 are incorrect, the next iteration 108 may be re-executed at 110 before the following iteration 112 may be executed. If the next iteration 108 contains many instructions to be re-executed, the delay caused by having to re-execute it can be significant, and, at best, provides no advantage over regular sequential processing.

### Definitions

Components/terminology used herein for one or more embodiments of the invention are described below:

In some embodiments, “computer” may refer to any apparatus that is capable of accepting a structured input, processing the structured input according to prescribed rules, and producing results of the processing as output. Examples of a computer may include: a computer; a general purpose computer; a supercomputer; a mainframe; a super mini-computer; a mini-computer; a workstation; a microcomputer; a server; an interactive television; a hybrid combination of a computer and an interactive television; and application-specific hardware to emulate a computer and/or software. A computer may have a single processor or multiple processors, which may operate in parallel and/or not in parallel. A computer may also refer to two or more computers connected together via a network for transmitting or receiving information between the computers. An example of such a computer may include a distributed computer system for processing information via computers linked by a network.

In some embodiments, a “machine-accessible medium” may refer to any storage device used for storing data accessible by a computer. Examples of a machine-accessible medium may include: a magnetic hard disk; a floppy disk; an optical disk, such as a CD-ROM or a DVD; a magnetic tape; a memory chip; and a carrier wave used to carry machine-accessible electronic data, such as those used in transmitting and receiving e-mail or in accessing a network.

In some embodiments, “software” may refer to prescribed rules to operate a computer. Examples of software may include: code segments; instructions; computer programs; and programmed logic.

In some embodiments, a “computer system” may refer to a system having a computer, where the computer may comprise a computer-readable medium embodying software to operate the computer.

### BRIEF DESCRIPTION OF THE DRAWINGS

The foregoing and other features and advantages of the invention will be apparent from the following, more particular description of embodiments of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of speculative parallel thread execution;

FIG. 2 depicts an exemplary embodiment of a method according to the present invention;

FIG. 3A depicts a segment of exemplary sequential loop program code;

FIG. 3B depicts an exemplary dependence graph according to an embodiment of the present invention;

FIG. 3C depicts an exemplary SPT transformation of the sequential loop in FIG. 3A according to an embodiment of the present invention;

FIG. 4 depicts an exemplary embodiment of a method of loop partitioning according to the present invention; and

FIG. 5 depicts a conceptual block diagram of a computer system that may be used to implement an embodiment of the invention.

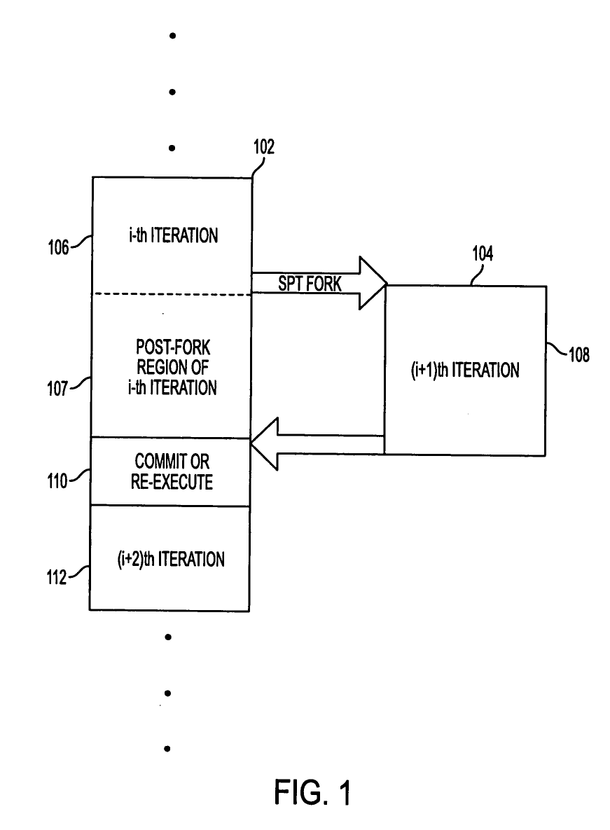

### DETAILED DESCRIPTION OF AN EXEMPLARY EMBODIMENT OF THE PRESENT INVENTION

Embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

In an exemplary embodiment, the method of the present invention may be part of a compiler and may optimally transform a sequential computer program loop into a speculative parallel thread (SPT) execution loop during code compilation. The SPT loop may be optimized such that the cost of re-execution (i.e., the misspeculation cost) is minimized subject to the constraint that the pre-fork region partition size does not exceed a pre-specified maximum requirement.

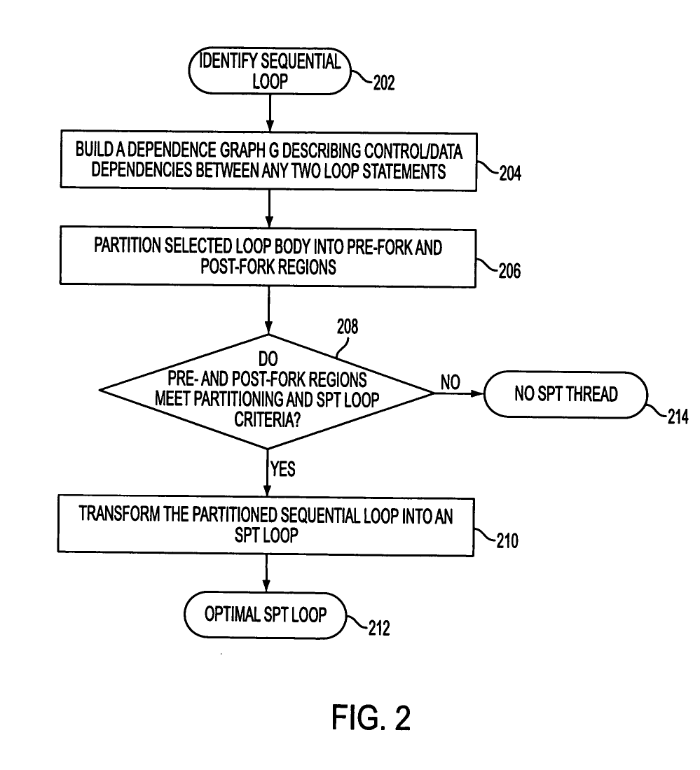

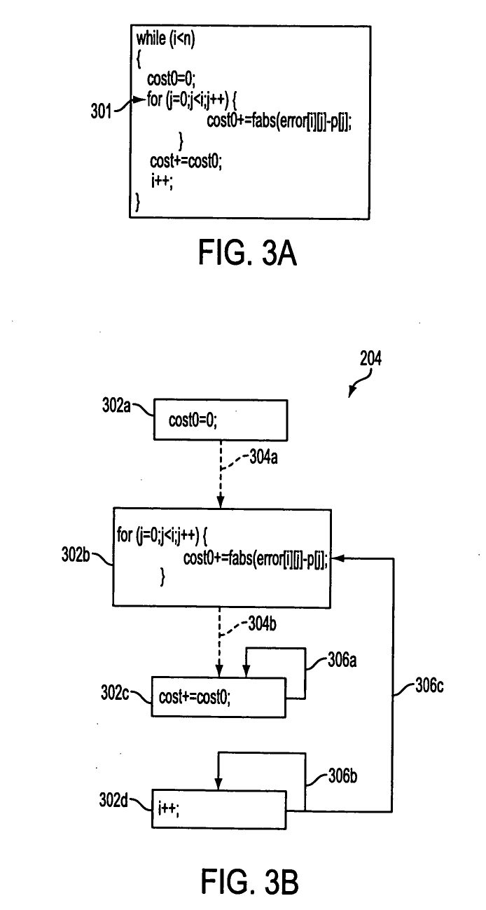

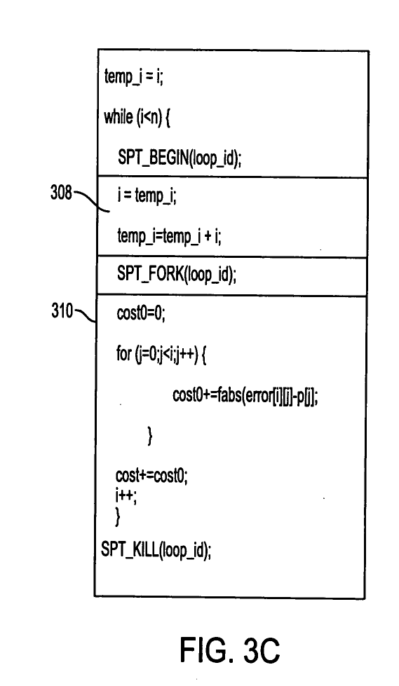

FIG. 2 depicts an exemplary embodiment of a method according to the present invention. When a sequential loop is identified in the program code in block 202, a dependence graph G(V,E) may be built in block 204 from the set V of statements in the loop and the set E of control and data dependence edges. The construction of the graph G is discussed in more detail with respect to FIG. 3. Then, using the graph G, the sequential loop may be partitioned into a pre-fork region and a post-fork region in block 206. The pre-fork region is the part of the loop that is performed prior to a fork instruction, which will fork a speculative parallel thread (SPT). The post-fork region is the part of the loop that will be executed by the master thread after the SPT is forked.

The resulting pre- and post-fork regions may be optimal for that loop. Then, if the pre- and post-fork regions meet specified partitioning and SPT loop criteria at block 208, the loop may be transformed into an optimal SPT loop 212 in block 210. If the pre- and post-fork regions do not meet the partitioning criteria, then the sequential loop may not be a candidate for SPT partitioning and the process may continue with block 214, where no SPT is created.

FIG. 3A shows an example of a sequential loop 301. FIG. 3B depicts an exemplary embodiment of a dependence graph G built for the sequential loop 301 according to an embodiment of the present invention. In this example, the sequential loop 301 has four statements 302a, 302b, 302c and 302d (collectively 302), which form the set V of statements for the loop 301. Each statement 302 may be a node in the graph G. The edges E may be represented as arrows 304a, 304b (collectively 304) and arrows 306a, 306b, and 306c (collectively 306). The arrows 304 may represent intra-iteration dependencies, e.g., segment 302b may depend on a value from 302a in the current iteration only. The arrows 306 may represent across-iteration dependencies. Across-iteration dependencies are dependencies between code segments that span iterations. For example, segment 302b may depend on the value of the variable “i” from segment 302d from the previous iteration. In an exemplary embodiment, a segment that originates an across-iteration dependency, e.g., segments 302c and 302d, may be a violation candidate. Violation candidates that have high misspeculation costs may be moved into the pre-fork region in block 210.

In the dependence graph G that may result from block 204, all intra-iteration edges may be forward edges (i.e., the arrows 304 may all point toward the bottom of the loop in FIG. 3B), while most across-iteration edges may be backward edges (i.e., the arrows 306 may lead toward the top of the loop in FIG. 3B). In an exemplary embodiment of the present invention, during partitioning, segments may only be moved from the post-fork region into the pre-fork region. In order to maintain the correctness of the program code, all of the intra-iteration edges may remain forward edges. With respect to the example in FIG. 3B, this would mean that if segment 302c were to be moved into the pre-fork region, then regions 302a and 302b would also be moved into the pre-fork region. As long as all of the intra-iteration edges remain forward edges in a partitioning of the loop, the partition is said to be legal.

Once the dependence graph G is built for the sequential loop, the loop may be partitioned in block 206. An optimal partition, if one exists, may be found within the set of legal partitions. In an exemplary embodiment, the method of the present invention may search in the set of legal partitions that include the movement of violation candidates, because only the movement of violation candidates may reduce the misspeculation cost. For all of the possible legal partitions that may include a movement of at least one violation candidate into the pre-fork region, the resulting size of the pre-fork region S and the number of re-executed instructions in the speculative executed iteration (i.e., the misspeculation cost) C may be considered. If the size S of the pre-fork region is too large compared to a maximum allowed size, then the partition may not be optimal. The partition with the smallest misspeculation cost C that still meets the pre-fork region size S requirement may be the optimal partition.

When a violation candidate is not moved into the pre-fork region of the partition, all program code that depends on the violation candidate in the next iteration may be executed incorrectly in the speculative thread, and if so would need to be re-executed by the master thread.

The table shown in FIG. 7 illustrates an example of possible partitions based on the code segment shown in FIGS. 3A and 3B, based on the example segment size values shown in the table in FIG. 6.

If the maximum pre-fork region size is set, for example, at 5, there may be only two possible partitions, as seen in FIG. 7. However, only the pre-fork partition C consisting of segment 302d may have both a small enough pre-fork size (1) and a minimum misspeculation cost (1). The misspeculation cost is the number of re-executed instructions in the speculative executed iteration. If this optimal partition meets other SPT loop selection criteria, for example, loop body size and misspeculation cost, the loop may then be transformed into an SPT fork.

FIG. 3C shows an exemplary transformation of the original sequential loop 301 according to an embodiment of the present invention. The segment 302d has been moved into a pre-fork region 308. The remaining segments 302a, 302b, and 302c have been transformed into a post-fork region 310.

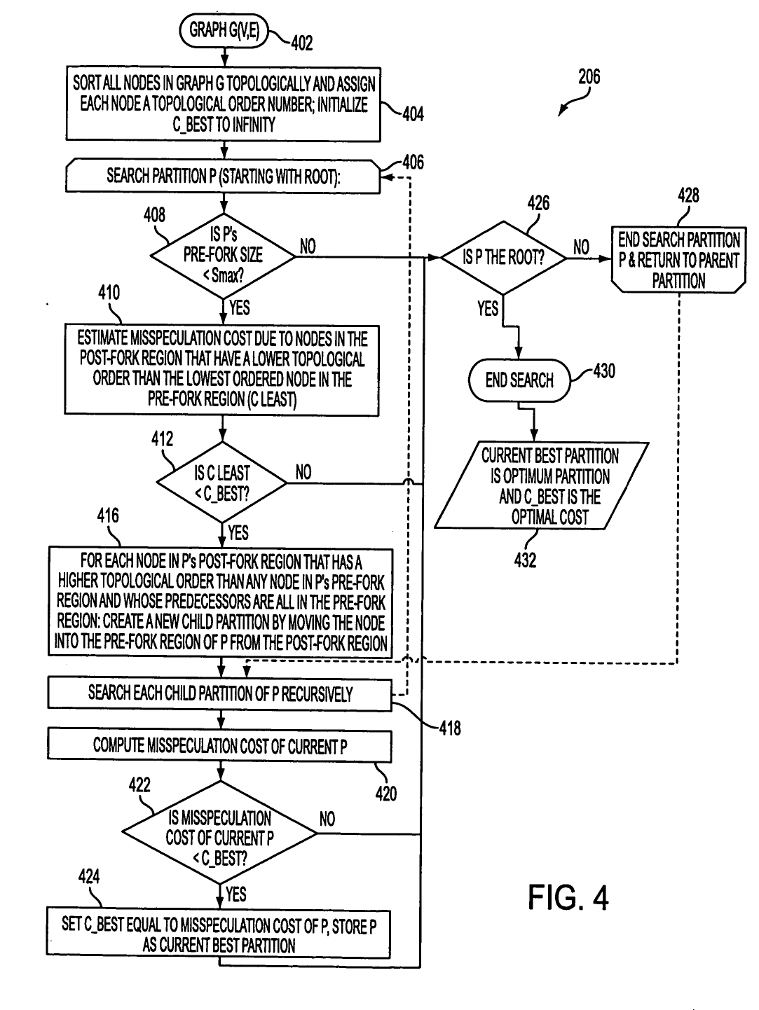

FIG. 4 shows a flowchart describing an example of how block 206 may be implemented, to partition a sequential loop, according to an embodiment of the present invention. Beginning with the dependence graph G(V,E) among violation candidates at 402, each segment, or “node”, in the graph may be ordered topologically with respect to the intra-iteration dependence edges, and may then be numbered in topological order in block 404. For example, if a graph has two nodes A and B, where node B depends on node A within an iteration, node B may be given a higher topological order number than node A. Additionally in block 404, a current lowest misspeculation cost for the entire loop (C_best) may be initialized to a very large number, for example, infinity. Once the graph is constructed, a maximum allowed pre-fork size, Smax, may be determined (not shown), for example, by setting Smax to be a percentage of the total loop size.

Next, starting with the root partition, which is the partition having an empty pre-fork region, e.g., partition A in FIG. 7, each potential optimal partition P of the loop may be searched iteratively as shown in block 406. If the partition P has a pre-fork size larger than Smax at 408, then the partition P may be rejected, and if P is not the root at 426, the search may return to the parent partition of P at 428. If P is the root partition, then the search may end at 430, and the current best partition and misspeculation cost may be designated as the optimal partition and misspeculation cost, respectively, at 432.

If the partition P has a pre-fork size smaller than Smax at 408, then the combined misspeculation cost of any nodes in the partition P having a lower topological order number than any of the nodes in the pre-fork region may be estimated in step 410. This cost, C_least, may be the lower bound of the optimal misspeculation cost all of the child partitions of P, because those nodes (having a lower topological order number than any of the pre-fork nodes) may never be moved into the pre-fork region. If C_least is higher than C_best at 412, the partition P may be rejected, and the search may either end at 430 or may return to the parent partition of P at 428. If C_least is smaller than C_best at 412, then, for each node in the post-fork region of P that has a higher topological order number than any node in the pre-fork region and whose predecessors are all in the pre-fork region, a new child partition P′ may be created by moving one such node from the post-fork region into the pre-fork region in block 416. A child partition is defined as a partition having one more node in the pre-fork region than its parent partition (here, P) has.

Each child partition of P may then be searched recursively in block 418, beginning at block 406. When all of the child partitions of P have been searched, the current misspeculation cost of P may be calculated in block 420. If that current misspeculation cost is larger than C_best at 422, the partition P may be rejected. If current misspeculation cost is not larger than C_best, the value of C_best may be updated to equal the current misspeculation cost of P, and partition P may be stored as the current best partition. If there are no other partitions to examine, i.e., if P is the root partition, the process may end at 430.

Once the optimal partition is found, if the partition meets an additional set of criteria, the sequential loop may be transformed into an SPT loop. The criteria may include, for example, but are not limited to, a minimum and a maximum loop size, a maximum ratio of pre-fork region size to loop size, and a maximum ratio of misspeculation cost to loop size. As seen, for example, in FIG. 3C, transformation into an SPT loop may include moving code segments into a pre-fork region, inserting temporary variables to maintain code correctness after the code re-ordering, and adding SPT fork instructions.

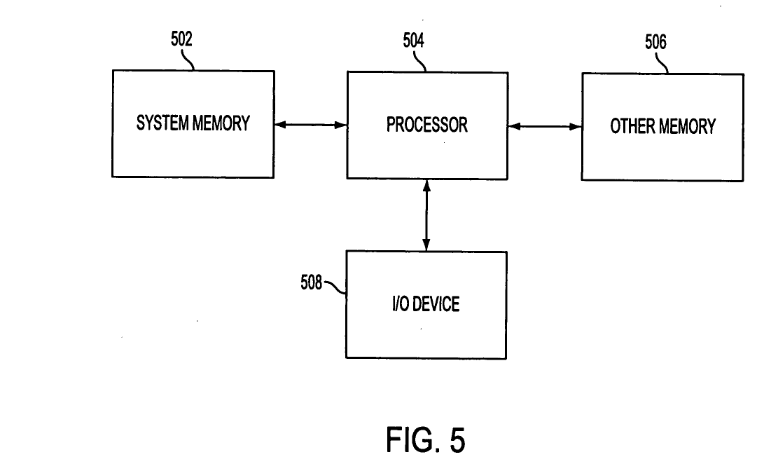

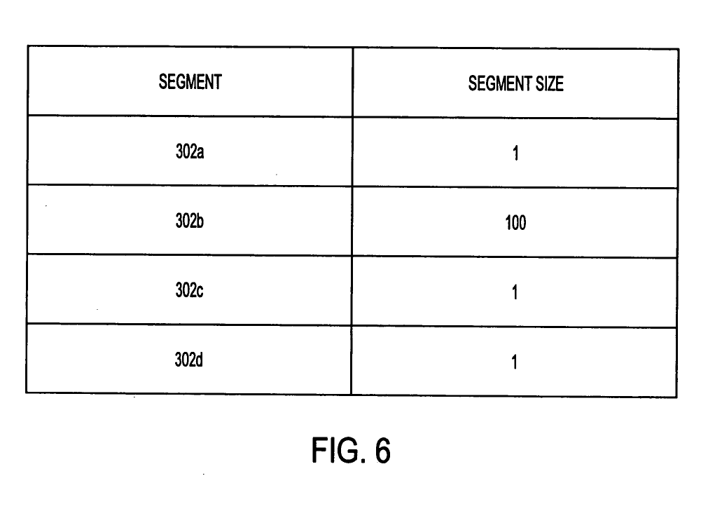

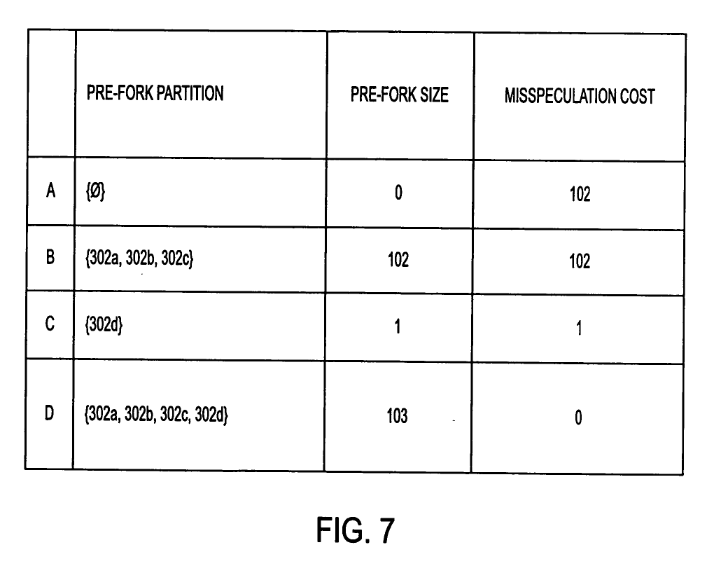

Some embodiments of the invention, as discussed above, may be embodied in the form of software instructions on a machine-accessible medium. Such an embodiment is illustrated in FIG. 5. The computer system of FIG. 5 may include at least one processor 504, with associated system memory 502, which may store, for example, operating system software and the like. The system may further include additional memory 506, which may, for example, include software instructions to perform various applications. System memory 502 and additional memory 506 may be implemented as separate memory devices, they may be integrated into a single memory device, or they may be implemented as some combination of separate and integrated memory devices. The system may also include one or more input/output (I/O) devices 508, for example (but not limited to), keyboard, mouse, trackball, printer, display, network connection, etc. The present invention may be embodied as software instructions that may be stored in system memory 502 or in additional memory 506. Such software instructions may also be stored in removable media (for example (but not limited to), compact disks, floppy disks, etc.), which may be read through an I/O device 508 (for example, but not limited to, a floppy disk drive). Furthermore, the software instructions may also be transmitted to the computer system via an I/O device 508, for example, a network connection; in this case, the signal containing the software instructions may be considered to be a machine-accessible medium.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method comprising:
building a dependence graph G(V,E), of a loop of a computer program, the loop including a set of program statements V and a set of control/data dependence edges E, G(V,E) having at least two nodes;
selecting a partition of the loop into a pre-fork region and a post-fork region according to said dependence graph, based on a misspeculation cost associated with said partition;
transforming the loop into a speculative parallel thread (SPT) loop based on said partition, if said partition and said associated misspeculation cost meet a set of transformation criteria.

2. The method of claim 1, wherein said building a dependence graph comprises:
creating a separate node for each program statement in the loop;
creating an intra-iteration dependence edge between a first node and a second node when said second node depends on said first node in a current iteration; and
creating an across-iteration dependence edge between a first node and a second node when said second node depends on said first node from a previous iteration.

3. The method of claim 2, wherein said selecting comprises:
considering only legal partitions.

4. The method of claim 1, wherein said selecting comprises: searching each possible partition of the loop for a partition having a pre-fork size less than a maximum allowed pre-fork size and having a lowest misspeculation cost of all possible partitions.

5. The method of claim 4, further comprising:
(a) sorting said dependence graph G topologically and assigning each node in said graph a topological order number;
(b) iterating for each partition P of the loop, beginning with a root partition having an empty pre-fork region:
(i) estimating a misspeculation cost (C_least) due to any nodes in said post-fork region of said partition P having a lower topological order number than a lowest ordered node in said pre-fork region of said partition P;
(ii) comparing C_least to an optimal cost (C_best) for said partition P;
(iii) creating a child partition P′ when C_least is smaller than C_best;
(iv) recursively searching each child partition P′ of P using 6(b)(i) to (iv);
(v) computing a misspeculation cost of said partition P when all child partitions P′ of P have been searched;
(vi) comparing said computed misspeculation cost of partition P to C_best;
(vii) setting C_best to be equal to said computed misspeculation cost for partition P, and storing said partition P as a current best partition; and
(c) ending said iterating for each partition P when all partitions have been considered.

6. The method of claim 5 comprising:
using 6(b)(ii)-(vi) only when a size of said pre-fork region of said partition P is not larger than said maximum allowed pre-fork size.

7. The method of claim 5, wherein 6(b)(ii) comprises moving one node from said post-fork region of P into said pre-fork region of P for each node in said post-fork region of P that has both a higher topological order number than any node in said pre-fork region of P and than all of its predecessor nodes in said pre-fork region of P.

8. The method of claim 1, wherein said set of transformation criteria comprises at least one of:
a minimum loop size, a maximum loop size, a maximum ratio of pre-fork region size to loop size, and a maximum ratio of misspeculation cost to loop size.

9. The method of claim 1, wherein said transforming comprises at least one of:
moving a code segment into said pre-fork region;
inserting code correcting temporary variables; and
adding SPT fork instructions.

10. A system, comprising:
at least one processor;
wherein the system is adapted to perform a method comprising:
building a dependence graph G(V,E), of a loop of a computer program, the loop including a set of program statements V and a set of control/data dependence edges E, G(V,E) having at least two nodes;
selecting a partition of the loop into a pre-fork region and a post-fork region according to said dependence graph, based on a misspeculation cost associated with said partition;
transforming the loop into a speculative parallel thread (SPT) loop based on said partition, if said partition and said associated misspeculation cost meet a set of transformation criteria.

11. The computer system according to claim 10, further comprising:
a machine-accessible medium containing software code that, when executed by said at least one processor, causes the system to perform said method.

12. The computer system according to claim 11, further comprising:
an input/output device adapted to read said machine-accessible medium.

13. A machine-accessible medium containing software code that, when read by a computer, causes the computer to perform a method comprising:
building a dependence graph G(V,E), of a loop of a computer program, the loop including a set of program statements V and a set of control/data dependence edges E, G(V,E) having at least two nodes;
selecting a partition of the loop into a pre-fork region and a post-fork region according to said dependence graph, based on a misspeculation cost associated with said partition;
transforming the loop into a speculative parallel thread (SPT) loop based on said partition, if said partition and said associated misspeculation cost meet a set of transformation criteria.

14. The machine-accessible medium of claim 13, wherein said step of building a dependence graph comprises:
creating a separate node for each program statement in the loop;
creating an intra-iteration dependence edge between a first node and a second node when said second node depends on said first node in a current iteration; and
creating an across-iteration dependence edge between a first node and a second node when said second node depends on said first node from a previous iteration.

15. The machine-accessible medium of claim 14, wherein said selecting comprises:
considering only legal partitions.

16. The machine-accessible medium of claim 13, wherein said selecting comprises:
searching each possible partition of the loop for a partition having a pre-fork size less than a maximum allowed pre-fork size and having a lowest misspeculation cost of all possible partitions.

17. The machine-accessible medium of claim 16, further comprising:
(a) sorting said dependence graph G topologically and assigning each node in said graph a topological order number;
(b) iterating for each partition P of the loop, beginning with a root partition having an empty pre-fork region:
(i) estimating a misspeculation cost (C_least) due to any nodes in said post-fork region of said partition P having a lower topological order number than a lowest ordered node in said pre-fork region of said partition P;
(ii) comparing C_least to an optimal cost (C_best) for said partition P;
(iii) creating a child partition P′ when C_least is smaller than C_best;
(iv) recursively searching each child partition P′ of P using 6(b)(i) to (iv);
(v) computing a misspeculation cost of said partition P when all child partitions P′ of P have been searched;
(vi) comparing said computed misspeculation cost of partition P to C_best;
(vii) setting C_best to be equal to said computed misspeculation cost for partition P, and storing said partition P as a current best partition; and
(c) ending said iterating for each partition P when all partitions have been considered.

18. The method machine-accessible medium of claim 17 comprising:
using 6(b)(ii)-(vi) only when a size of said pre-fork region of said partition P is not larger than said maximum allowed pre-fork size.

19. The machine-accessible medium of claim 13, wherein said set of transformation criteria comprises at least one of:
a minimum loop size, a maximum loop size, a maximum ratio of pre-fork region size to loop size, and a maximum ratio of misspeculation cost to loop size.

20. The machine-accessible medium of claim 13, wherein said transforming comprises at least one of:
moving a code segment into said pre-fork region;
inserting code correcting temporary variables; and adding SPT fork instructions.
